(19) United States
(12) Patent Application Publication
(10) Pub. No.: US 2026/0242254 A1
(43) Pub. Date: Aug. 20, 2026

(54) CONTROL DEVICE, CONTROL METHOD, AND CONTROL PROGRAM

(71) Applicant: Yokogawa Electric Corporation, Tokyo (JP)

(72) Inventors: Yasuhiro MATSUI, Tokyo (JP); Junji KAMIGUCHI, Tokyo (JP)

(21) Appl. No.: 19/160,724

(22) PCT Filed: Mar. 1, 2024
(86) PCT No.: PCT/JP2024/007855

§ 371 Date: Aug. 28, 2025

(30) Foreign Application Priority Data
Mar. 3, 2023 (JP) 2023-033037

(51) Int. Cl. C02F 1/44; C02F 1/76

(52) U.S. Cl. CPC C02F 1/44; C02F 1/76; C02F 2209/006; C02F 2209/03; C02F 2209/29; C02F 2209/44; C02F 2303/20

(57) ABSTRACT

A control device includes an obtaining unit and a decision making unit. In the inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used; the obtaining unit obtains water quality information related to the water quality of the feed water which is supplied to the MF membrane or the UF membrane of the membrane filtration device. According to the water quality information, the decision making unit decides on the quantity of sodium hypochlorite to be added into the MF membrane or the UF membrane of the membrane filtration device.

### TECHNICAL FIELD

The present invention relates to a control device, a control method, and a control program.

### BACKGROUND ART

Conventionally, a water treatment system is known in which the treatment water is cleaned using a membrane filtration device that includes filtration membranes. In the water treatment system, for example, in order to remove the organic substances included in the treatment water, chemicals such as sodium hypochlorite are used.

In a water treatment system targeted at treating sewage treatment water, ammonia present in the sewage treatment water reacts with sodium hypochlorite, thereby resulting in the generation of chloramine. Then, chloramine reacts with NDMA precursors, which sometimes results in the generation of NDMA (N-nitrosodimethylamine).

In order to remove NDMA, in the latter stage of the membrane filtration device, treatment is carried out using the advanced oxidation process in which ultraviolet (UV) rays and an oxidizing agent are combined. As a result of performing the UV advanced oxidation process, NDMA is removed to a level equal to or lower than the reference value.

### CITATION LIST

### Patent Literature

PTL 1: Japanese Laid-open Patent Publication No. 2020-104093

### SUMMARY OF INVENTION

### Technical Problem

When the water to be treated is drainage water such as sewage water or rainwater, there are times when the ammonia content in the drainage water is not stable. Hence, in a water treatment system meant for treating drainage water, in order to remove the organic substances in a more reliable manner, sodium hypochlorite or ammonium sulphate (or ammonium chloride) is added in excess quantity.

If sodium hypochlorite is added in excess quantity, it leads to more reliable acceleration in the reaction between ammonia, which is present in the sewage treatment water, and sodium hypochlorite. However, a greater amount of chloramine also gets generated, thereby sometimes resulting in the generation of a greater amount of NDMA.

For that reason, in the UV advanced oxidation process, there occurs an increase in the UV irradiance and the UV irradiation time, thereby leading to an increase in the treatment cost.

As an aspect, it is an objective to further reduce the treatment cost of a water treatment system.

### Solution to Problem

According to an aspect, a control device includes an obtaining unit and a decision making unit. In the inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used; the obtaining unit obtains water quality information related to the water quality of the feed water which is supplied to the MF membrane or the UF membrane of the membrane filtration device. According to the water quality information, the decision making unit decides on the quantity of sodium hypochlorite to be added into the MF membrane or the UF membrane of the membrane filtration device.

### Advantageous Effects of Invention

According to an embodiment, it becomes possible to further reduce the treatment cost of a water treatment system.

### BRIEF DESCRIPTION OF DRAWINGS

FIG. 1 is a diagram illustrating the relationship between the addition of sodium hypochlorite and the chlorine residue.

FIG. 2 is a diagram illustrating an exemplary control operation according to an embodiment.

FIG. 3 is a diagram illustrating an exemplary configuration of a water treatment device according to the present embodiment.

FIG. 4 is a diagram illustrating an exemplary configuration of an RO membrane filtration device according to the present embodiment.

FIG. 5 is a block diagram illustrating an exemplary configuration of a control device according to the present embodiment.

FIG. 6 is a flowchart for explaining an exemplary flow of a first decision making operation according to the present embodiment.

FIG. 7 is a flowchart for explaining an exemplary flow of a cleaning decision making operation according to the present embodiment.

FIG. 8 is a flowchart for explaining an exemplary flow of a second decision making operation according to the present embodiment.

FIG. 9 is a diagram for explaining an exemplary hardware configuration of the control device.

### DESCRIPTION OF EMBODIMENTS

An exemplary embodiment of a control device, a control method, and a control program according to the application concerned is described below in detail with reference to the accompanying drawings. However, the present invention is not limited by the embodiment described below. Moreover, identical constituent elements are referred to by the same reference numerals, and the same explanation is not given again. Furthermore, it is possible to combine embodiments without causing any contradictions in the operation details.

### <1. To Start With>

### <1.1. Problem>

The water treatment of drainage water, such as sewage water or rainwater, is generally classified into three main types of treatment, namely, primary treatment, secondary treatment, and tertiary treatment.

In the primary treatment, large solid objects such as foreign substances are removed from the drainage water. In the secondary treatment, the organic substances that could not be removed in the primary treatment are removed using microorganisms (bacteria). In the secondary treatment, for example, activated sludge treatment and nitrification denitrification reaction treatment is performed. In the tertiary treatment, free-floating solid objects that could not be removed in the secondary treatment are removed by precipitation. In the tertiary treatment, sand filtration or membrane filtration is used to remove the free-floating solid objects.

In the secondary treatment, a large number of microorganisms are present in the drainage water, and those microorganisms perform oxidative decomposition of the organic substances. Then, the microorganisms settle down and are removed as sediment. After the removal of the sediment, the drainage water still contains the microorganisms that did not settle down and contains viruses attached to microbes.

When chlorine (sodium hypochlorite) is added to the sewage treatment water (secondary treatment water or tertiary treatment water), it results in the removal of the microorganisms and the viruses. Thus, a water treatment system 10 enables preventing propagation of microorganisms and viruses, and enables holding down the blockage of the filtration membranes during the membrane filtration performed in the latter stage.

To the drainage water, sodium hypochlorite is added in excess quantity that is in excess of a stable value. When sodium hypochlorite is added in excess quantity, the microorganisms or the viruses are removed in a more reliable manner.

As a result of adding sodium hypochlorite (chlorine) to the drainage water, combined chlorine (chloramine) is generated from ammonia (NH₄—N).

Generally, the types of combined chlorine present in water differ according to Reaction Formulae (1) to (4) given below and according to the chemical equilibrium.

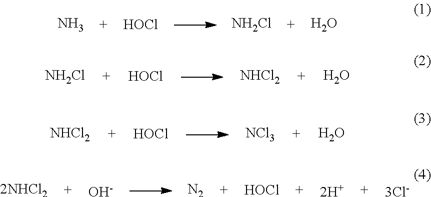

As given above in Reaction Formulae (1) to (4), according to the water quality condition, ammonia (NH₃) gets converted into three main types of combined chlorine (namely, monochloramine (NH₂C₁), dichloramine (NHCl₂), and trichloramine (NCl₃)).

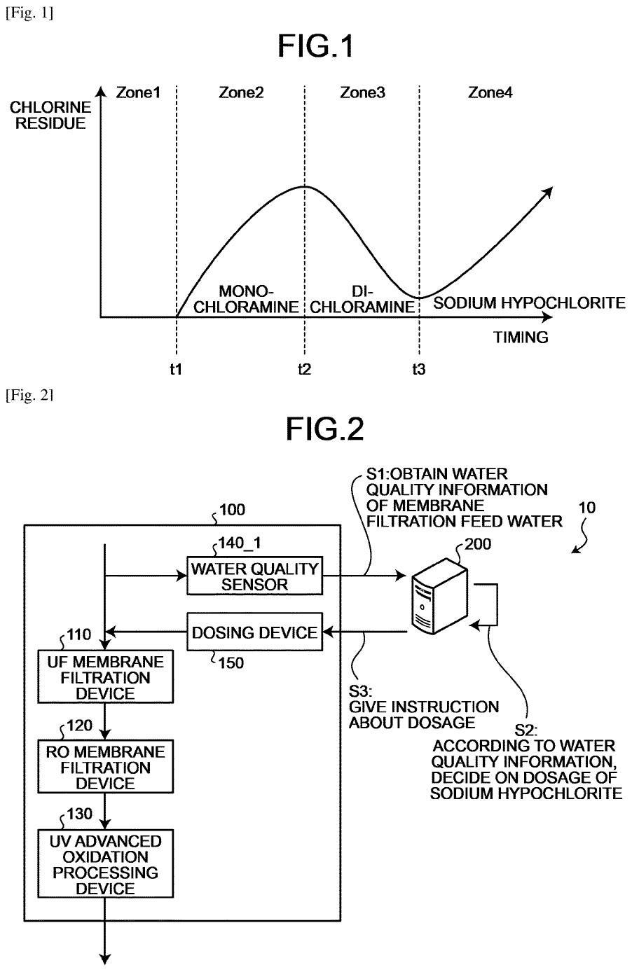

FIG. 1 is a diagram illustrating the relationship between the addition of sodium hypochlorite and the chlorine residue. In FIG. 1 is illustrated a graph of the chlorine residue in the case in which a constant quantity of sodium hypochlorite is added to ammonia water per unit time. In the graph illustrated in FIG. 1, the horizontal axis represents the time and the vertical axis represents the chlorine residue.

More particularly, during the period of time from the start of addition of sodium hypochlorite to a first timing t1 (i.e., during a zone 1), sodium hypochlorite gets consumed by the microorganisms, and is not detected from the treatment water. The first timing t1 varies according to the number of microorganisms included in the treatment water.

Subsequently (i.e., after the first timing t1), during the period of time till a second timing t2 (i.e., during a zone 2), the reaction given in Reaction Formula (1) becomes predominant, and monochloramine starts getting detected as a result of binding of ammonia and sodium hypochlorite.

If more sodium hypochlorite is continually added, during the period of time from the second timing t2 to a third timing t3 (i.e., during a zone 3), the reaction given in Reaction Formula (2) becomes predominant, and dichloramine starts getting detected. If still more sodium hypochlorite is continually added; then, during the period of time after the timing t3 (i.e., during a zone 4), sodium hypochlorite starts getting detected. The second timing t2 and the third timing t3 vary according to the amount of ammonia present in the drainage water.

The timing t2 is not explicitly definable, and the timing of generation of dichloramine varies according to the changes in the water quality. Hence, in order to hold down the generation of dichloramine, the water quality is controlled by an expert supervisor.

The number of microorganisms and the amount of ammonia present in the water to be treated varies according to the water quality of the sewage water and according to the primary treatment and the secondary treatment. In order to remove the microorganisms in a more reliable manner, usually sodium hypochlorite and ammonia (for example, ammonium sulphate or ammonium chloride) is added in excess quantity to the treatment water.

In this way, when sodium hypochlorite and ammonium sulphate (or ammonium chloride) is added in excess quantity, the cost goes up due to an increase in the usage of such chemicals.

Moreover, due to excessive addition of sodium hypochlorite, NDMA also increases. NDMA is generated due to the reaction between chloramine and NDMA precursors. Particularly, it is a known fact that chloramine causes explosive generation of NDMA.

For example, in America, there is an established standard which indicates that NDMA content in drinking water should be equal to or lower than 10 mg/L. Meanwhile, NDMA generated due to the addition of sodium hypochlorite is not removed during membrane filtration. On the other hand, NDMA is decomposed during the UV advanced oxidation process (Post AOP (photooxidation/advanced oxidation)) performed after membrane filtration.

When a large quantity of sodium hypochlorite is added to the treatment water, in addition to an increase in the cost attributed to an increased usage of sodium hypochlorite, it also results in an increase in the burden on UV advanced oxidation that is meant for removing NDMA. Because of an increase in the burden on UV advanced oxidation, there occurs an increase in the period of time required for the treatment and an increase in the cost of treatment using a water treatment system.

On the other hand, if only a small quantity of sodium hypochlorite is added to the sewage water, then the microorganisms present in the sewage water are not completely removed. Thus, due to the microorganisms that could not be removed, there occurs a decline in the permeability of the filtration membranes used in membrane filtration, and the quality of the treated water (recycled water) deteriorates.

In this way, in the water treatment system, there is a tradeoff between the quality of the recycled water and the cost for recycling the sewage water. Hence, while maintaining the quality of the recycled water, the operations need to be controlled to ensure that the cost goes down.

Meanwhile, as a result of excess addition, there is a large amount of chlorine residue in the sewage water. As a result, the filtration membranes (for example, an MF membrane (MicroFiltration membrane), an UF membrane (UltraFiltration membrane), an NF membrane (NanoFiltration Membrane), and an RO membrane (ReverseOsmosis membrane) become susceptible to breakage. In order to prevent that problem, it is becoming mainstream to use a chlorine resistant material (for example, polyvinylidene fluoride (PVDF)) as the material for the filtration membranes. Meanwhile, for an NF membrane or an RO membrane, the use of a polyamide of the cross-linkable aromatic series is mainstream, and it is known that the polyamide suffers damage such as oxidative decomposition due to dichloramine.

In a membrane in which PVDF is used, if the membrane surface or the pores get blocked, it leads to a decrease in the quantity of filtrate water. In order to secure the quantity of filtrate water, the sewage water needs to be supplied to the filtration membrane with a higher pressure. That is, the pump used for supplying the sewage water to the filtration membrane needs to operate with higher pressure, thereby resulting in an increase in the energy consumption of the pump.

In this way, there are times when the use of PVDF cannot be said to be contributing in reducing the cost of the water treatment system, and there is a demand for a more appropriate improvement plan.

Herein, in order to resolve the blockage, a filtration membrane (for example, an MF membrane or an UF membrane) is cleaned on a periodic basis. Examples of cleaning an MF membrane or an UF membrane include reverse cleaning (i.e., cleaning performed using the filtrate water), cleaning performed using a chemical (such as sulfuric acid, citric acid, or sodium hypochlorite) (maintenance cleaning: MC), and chemical cleaning in which a high-concentration chemical is used for long-time immersion (recovery cleaning: RC).

During membrane filtration, an operation sequence that includes filtration using a filtration membrane (for example, an MF membrane or an UF membrane), cleaning as explained above, and other treatments is set (as the initial setting) in the design stage. Usually, this initial setting (i.e., setting based on the initial conditions) is almost never changed or optimized by the user.

An NF membrane or an RF membrane, which is disposed after an MF membrane or an UF membrane, is vulnerable to damage due to high-concentration chloramine or high-concentration dichloramine. Hence, in order to ensure that the NF membrane or the RO membrane is not damaged, the chloramine concentration needs to be controlled within an appropriate concentration range.

### <1.2. Overview of Control Operation>

In the present embodiment, a control device configured to control the water treatment obtains, in the inflow portion of a membrane filtration device, water quality information related to the water quality of the feed water (equivalent to the drainage water mentioned earlier) supplied to the membrane filtration device. According to the water quality information, the control device decides on the quantity of sodium hypochlorite to be added into the membrane filtration device.

As a result, the control device becomes able to hold down the concentration of chloramine, which is generated as a result of adding sodium hypochlorite, to a predetermined concentration (for example, in the zone 1 in which monochloramine is formed). As a result, it becomes possible to hold down the generation of NDMA.

Moreover, since the control device decides on the quantity of sodium hypochlorite for addition according to the water quality, there is no excessive addition of sodium hypochlorite in the membrane filtration device. As a result, the control device can control the usage of sodium hypochlorite in a more appropriate manner, and thus enables lowering the cost.

Explained below with reference to FIG. 2 is an exemplary control operation performed by the control device.

FIG. 2 is a diagram illustrating an exemplary control operation according to the present embodiment. The water treatment system 10 illustrated in FIG. 2 includes a water treatment device 100 and a control device 200. The water treatment device 100 recycles sewage treatment water, which is obtained by treating drainage water such as sewage water or rainwater, into daily life water or drinking water.

The water treatment device 100 is supplied with, for example, treatment water obtained by performing the activated sludge treatment and the nitrification denitrification reaction treatment on drainage water (i.e., treatment water subjected to the primary treatment and the secondary treatment). Then, the water treatment device 100 performs membrane treatment on the treatment water supplied thereto. That is, the water treatment device 100 performs water treatment mainly aimed at reusing the secondary treatment water or the tertiary treatment water mentioned earlier.

After being treated in the water treatment device 100, the treatment water is disinfected using, for example, chlorine and is used as daily life water or drinking water.

The activated sludge treatment and the nitrification denitrification reaction treatment are performed in, for example, a sewage water treatment facility. The water treatment device 100 performs membrane treatment on, for example, the drainage water that has been treated in a sewage water treatment facility.

The water treatment device 100 illustrated in FIG. 2 includes an UF membrane filtration device 110, an RO membrane filtration device 120, an UV advanced oxidation processing device 130, a water quality sensor 140_1, and a dosing device 150.

The UF membrane filtration device 110 removes microorganisms and particulate matter from the feed water using a filtration membrane. The filtration membrane of the UF membrane filtration device 110 is, for example, an ultrafiltration membrane (UF membrane). Meanwhile, only to simplify the following explanation, it is assumed that the water treatment device 100 performs membrane filtration using an ultrafiltration membrane (UF membrane). However, alternatively, the water treatment device 100 can perform membrane filtration using some other filtration membrane other than an UF membrane. For example, the water treatment device 100 can perform membrane filtration using a microfiltration membrane (MF membrane). In the case in which the water treatment device 100 performs membrane filtration using an MF membrane, the term “UF membrane” in the following explanation can be substituted with the term “MF membrane”.

The RO membrane filtration device 120 is supplied with the treatment water from the UF membrane filtration device 110. The RO membrane filtration device 120 removes impurity such as ions and salts from the feed water. The RO membrane filtration device 120 includes a reverse osmosis membrane (RO membrane). Meanwhile, only to simplify the following explanation, it is assumed that the water treatment device 100 performs membrane filtration using a reverse osmosis membrane (RO membrane). However, alternatively, the water treatment device 100 can perform membrane filtration using some other filtration membrane other than an RO membrane. For example, the water treatment device 100 can perform membrane filtration using an NF membrane. In the case in which the water treatment device 100 performs membrane filtration using an NF membrane, the term “RO membrane” in the following explanation can be substituted with the term “NF membrane”.

The UV advanced oxidation processing device 130 is supplied with the treatment water from the RO membrane filtration device 120. The UV advanced oxidation processing device 130 performs the advanced oxidation process by bombarding UV rays onto the feed water and removes NDMA.

The feed water supplied to the UF membrane filtration device 110 is also referred to as membrane filtration feed water. The feed water supplied to the RO membrane filtration device 120 is also referred to as reverse-osmosis membrane feed water. The feed water supplied to the UV advanced oxidation processing device 130 is also referred to as UV feed water.

The water quality sensor 140_1 is disposed in the inflow portion of the UF membrane filtration device 110. The water quality sensor 140_1 measures the water quality of the membrane filtration feed water.

For example, the water quality sensor 140_1 measures at least one of the following information regarding the membrane filtration feed water: the water temperature, the pH value, the ORP (Oxidation-Reduction Potential), the ammoniacal nitrogen content, the nitrogen compound content, the turbidity, the ultraviolet absorbance, the electrical conductivity, and the TOC (Total Organic Carbon) value.

Then, the water quality sensor 1401 outputs the measurement result to the control device 200.

The dosing device 150 follows an instruction from the control device 200 and adds chemicals to the inflow portion of the UF membrane filtration device 110. The dosing device 150 adds, for example, sodium hypochlorite to the inflow portion of the UF membrane filtration device 110. Moreover, other than sodium hypochlorite, the dosing device 150 adds a chemical such as ammonium sulphate or ammonium chloride to the inflow portion of the UF membrane filtration device 110.

The control device 200 controls the constituent elements of the water treatment device 100. The control device 200 according to the present embodiment performs the control operation illustrated in FIG. 2.

As far as the control operation is concerned, firstly, the control device 200 obtains information about the water quality information about the membrane filtration feed water from the water quality sensor 140_1 (Step S1).

The control device 200 decides on the dosage of sodium hypochlorite according to the water quality (Step S2). For example, the control device 200 decides on the dosage of sodium hypochlorite in such a way that there is less formation of dichloramine while a large number of microorganisms are removed from the membrane filtration feed water. More particularly, the control device 200 decides on the dosage in such a way that the membrane filtration feed water having sodium hypochlorite added thereto has the state in the zone 1 explained earlier.

The control device 200 instructs the dosing device 150 to add the decided dosage into the inflow portion of the UF membrane filtration device 110 (Step S3).

As a result, while holding down the dosage of sodium hypochlorite, the water treatment device 100 becomes able to remove the microorganisms and to hold down the generation of NDMA. Hence, it becomes possible to lower the treatment cost.

### <2. Exemplary System Configuration>

### <2.1. Exemplary Configuration of Water Treatment Device>

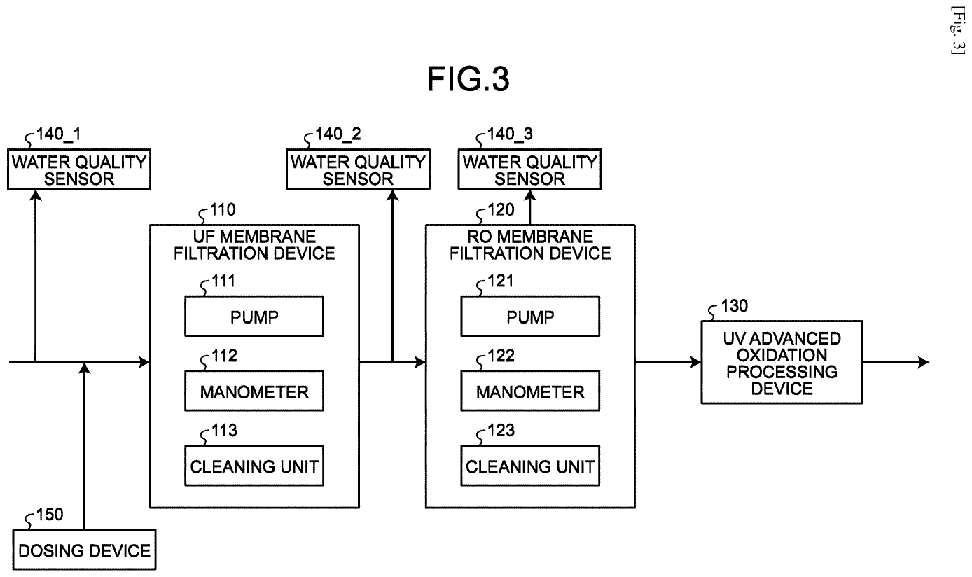

FIG. 3 is a diagram illustrating an exemplary configuration of the water treatment device 100 according to the present embodiment. The water treatment device 100 illustrated in FIG. 3 includes the UF membrane filtration device 110, the RO membrane filtration device 120, the UV advanced oxidation processing device 130, water quality sensors 140_1 to 1403, and the dosing device 150. Meanwhile, the water treatment device 100 illustrated in FIG. 3 is only exemplary. That is, the water treatment device 100 according to the present embodiment can include constituent elements other than the constituent elements illustrated in FIG. 3.

### (UF Membrane Filtration Device 110)

The UF membrane filtration device 110 includes an UF membrane (not illustrated in FIG. 3). Thus, the UF membrane filtration device 110 uses the UF membrane and performing membrane filtration of UF membrane feed water; and removes microorganisms and particulate matter. Then, the UF membrane filtration device 110 supplies membrane filtration permeable water (UF membrane permeable water), which is obtained as a result of membrane filtration, to the RO membrane filtration device 120.

The UF membrane filtration device 110 includes, for example, a pump 111, a manometer 112, and a cleaning unit 113.

The pump 111 is a feeder pump that feeds the UF membrane feed water to the UF membrane.

The manometer 112 measures the pressure of the inflow portion and the pressure of the outflow portion of the UF membrane filtration device 110. For example, the manometer 112 measures the pressure exerted by the UF membrane feed water onto the UF membrane filtration device 110. Moreover, the manometer 112 measures the pressure of the UF membrane permeable water that has passed through the UF membrane filtration device 110. Then, the manometer 112 outputs the measured pressure values to the control device 200 (see FIG. 2).

The cleaning unit 113 illustrated in FIG. 3 cleans the UF membrane according to an instruction issued from the control device 200 (see FIG. 2). For example, the cleaning unit 113 performs reverse cleaning, MC, and RC.

### (RO Membrane Filtration Device 120)

The RO membrane filtration device 120 illustrated in FIG. 3 includes an RO membrane (not illustrated in FIG. 3). The RO membrane filtration device 120 uses the RO membrane and desalinates (i.e., removes ionic material from) RO membrane feed water.

The RO membrane filtration device 120 includes, for example, a pump 121, a manometer 122, and a cleaning unit 123.

The pump 121 is a feeder pump that feeds the RO membrane feed water to the RO membrane. Meanwhile, the pump 121 can include a plurality of feeder pumps.

The manometer 122 measures the pressure of the inflow portion and the pressure of the outflow portion of the RO membrane filtration device 120. For example, the manometer 122 measures the pressure exerted by the RO membrane feed water onto the RO membrane filtration device 120. Moreover, the manometer 122 measures the pressure of the RO membrane permeable water that has passed through the RO membrane filtration device 120. Then, the manometer 122 outputs the measured pressure values to the control device 200 (see FIG. 2).

The cleaning unit 123 illustrated in FIG. 3 cleans the RO membrane according to an instruction issued from the control device 200 (see FIG. 2). For example, the cleaning unit 123 performs MC and RC.

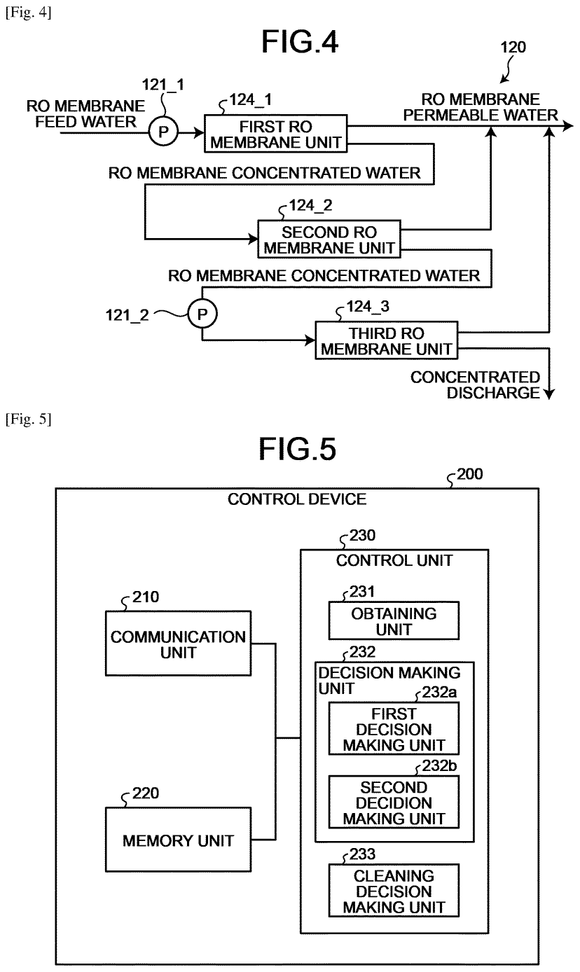

FIG. 4 is a diagram illustrating an exemplary configuration of the RO membrane filtration device 120 according to the present embodiment. The RO membrane filtration device 120 illustrated in FIG. 4 includes a first RO membrane unit 124_1 to a third RO membrane unit 124_3.

The first RO membrane unit 124_1 includes an RO membrane (not illustrated in FIG. 4). To the first RO membrane unit 124_1, the RO membrane feed water is supplied using, for example, a feeder pump 1211 (an example of the pump 121). Then, using the RO membrane, the first RO membrane unit 124_1 separates the RO membrane feed water into RO membrane permeable water (RO membrane filtered water) and RO membrane concentrated water. Subsequently, the first RO membrane unit 124_1 supplies the RO membrane concentrated water to the second RO membrane unit 124_2.

The second RO membrane unit 124_2 includes an RO membrane (not illustrated in FIG. 4). To the second RO membrane unit 1242, the RO membrane concentrated water is supplied from the first RO membrane unit 124_1. Then, using the RO membrane, the second RO membrane unit 1242 separates the RO membrane concentrated water into RO membrane permeable water and RO membrane concentrated water. Subsequently, the second RO membrane unit 124_2 supplies the RO membrane concentrated water to the third RO membrane unit 124_3.

The third RO membrane unit 124_3 includes an RO membrane (not illustrated in FIG. 4). To the third RO membrane unit 124_3, the RO membrane concentrated water is supplied from the second RO membrane unit 124_2 using, for example, a feeder pump 121_2 (an example of the pump 121). Then, using the RO membrane, the first RO membrane unit 124_3 separates the RO membrane concentrated water into RO membrane permeable water and RO membrane concentrated water. Subsequently, the first RO membrane unit 124_3 discharges the concentrated discharge to the outside of the water treatment device 100.

Moreover, the RO membrane filtration device 120 supplies the RO membrane permeable water to the UV advanced oxidation processing device 130 (see FIG. 3).

### (UV Advanced Oxidation Processing Device 130)

The UV advanced oxidation processing device 130 illustrated in FIG. 4 performs UV-AOP (advanced oxidation process using ultraviolet rays). As a result, the UV advanced oxidation processing device 130 causes oxidative decomposition of the trace chemical substances (for example, NDMA) present in the UV feed water.

### (Water Quality Sensors 140)

The water quality sensors 140 measure the water quality of the feed water or the filtrate water (the permeable water) in the constituent elements of the water treatment device 100. In the example illustrated in FIG. 3, the water treatment device 100 includes the water quality sensors 140_1 to 140_3.

The water quality sensor 140_1 measures the water quality in the inflow portion of the UF membrane filtration device 110. Thus, the water quality sensor 140_1 measures the water quality of the UF membrane feed water. For example, the water quality sensor 140_1 measures at least one of the following information regarding the UF membrane feed water: the water temperature, the pH value, the ORP, the ammoniacal nitrogen content, the nitrogen compound content, the turbidity, the ultraviolet absorbance, the electrical conductivity, and the TOC value. The water quality sensor 140_1 can include a plurality of sensors (for example, a thermometer, a pH meter, a turbidimeter, and an electric conductivity meter) for measuring the abovementioned values.

The water quality sensor 140_2 measures the water quality in the inflow portion of the RO membrane filtration device 120 (or in the outflow portion of the UF membrane filtration device 110). Moreover, the water quality sensor 140_2 measures the water quality of the RO membrane feed water (or the UF membrane permeable water). The water quality sensor 140_2 measures at least one of the following information regarding the RO membrane feed water: the water temperature, the pH value, the ORP, the TOC value, and microorganism data (about at least either viruses, or bacteria, or ATP (adenosine triphosphate)). The water quality sensor 140_2 can include a plurality of sensors (for example, a thermometer and a pH meter) for measuring the abovementioned values.

The water quality sensor 140_3 measures the water quality of the RO membrane concentrated water (or the concentrated discharge) in the RO membrane filtration device 120. The water quality sensor 140_3 measures at least one of the following information regarding the RO membrane concentrated water: the water temperature, the pH value, the ORP, the TOC value, and microorganism data (about at least either viruses, or bacteria, or ATP (adenosine triphosphate)). The water quality sensor 140_3 can include a plurality of sensors (for example, a thermometer and a pH meter) for measuring the abovementioned values.

Meanwhile, the water quality sensors 140 included in the water treatment device 100 are not limited to the example illustrated in FIG. 3. For example, as the water quality sensor 140 not illustrated in FIG. 3, the water treatment device 100 can include the water quality sensor 140 configured to measure the water quality of, for example, the UV feed water.

### (Dosing Device 150)

The dosing device 150 adds various types of chemicals into the inflow portion of the UF membrane filtration device 110. The dosing device 150 adds the chemicals according to an instruction issued from the control device 200 (see FIG. 2). For example, the dosing device 150 adds sodium hypochlorite into the membrane filtration feed water. Moreover, the dosing device 150 adds ammonium sulphate or ammonium chloride into the membrane filtration feed water.

Meanwhile, the dosing device 150 included in the water treatment device 100 is not limited to the example illustrated in FIG. 3. For example, as the dosing device 150 not illustrated in FIG. 3, the water treatment device 100 can include the dosing device 150 configured to add chemicals into the UV feed water.

In this way, in the inflow portion of the UF membrane filtration device 110 (in other words, the UF membrane), the dosing device 150 adds ammonium sulphate (or ammonium chloride) so as to cause formation of chloramine.

Herein, chloramine represents combined chlorine obtained when chlorine (in water (membrane filtration feed water), sodium hypochlorite is present in the form of hypochlorous acid HOCl or hypochlorite ions OCl⁻) is made to react with ammonia.

Generally, the type of combined chlorine present in water differs according to Reaction Formulae (1) to (4) given earlier and according to the chemical equilibrium.

As given in Reaction Formulae (1) to (4), according to the water quality condition, ammonia (NH₃) gets converted into three main types of combined chlorine (namely, monochloramine (NH₂C₁), dichloramine (NHCl₂), and trichloramine (NCl₃).

The oxidative power of chloramine and the disinfection effect on organisms becomes greater in order of monochloramine, dichloramine, and trichloramine. That is, the oxidative power and the disinfection effect on organisms is greater in dichloramine as compared to monochloramine, and is greater in trichloramine as compared to dichloramine. Meanwhile, hypochlorous acid and hypochlorite ions exhibit the greatest disinfection effect.

When the quantity of chlorine (sodium hypochlorite) added into the membrane filtration feed water increases and the ratio of sodium goes up with respect to ammonium, ammonium changes into monochloramine and then into dichloramine and trichloramine, disappears from the water in the form of nitrogen gas, and gets liberated as hypochlorous acid or hypochlorite ions.

In the present embodiment, the ratio of chlorine concentration and ammonia concentration (Cl₂:NH₃) in the membrane filtration feed water is set to be in the approximate range between 1:2.5 and 1:3. That is, the control device 200 sets NH₃/CL₂ in the membrane filtration feed water to in the range between 2.5 and 3 and, sets the dosage of ammonium sulphate (or ammonium chloride) and sodium hypochlorite with the aim of generating monochloramine.

The oxidative power of dichloramine, trichloramine, and free available chlorine is greater as compared to the oxidative power of monochloramine and, as reported in Reference Literature [1], such oxidative power causes deterioration in the RO membrane made of an aromatic polyamide material.

Moreover, as reported in Reference Literature [2], it is known that the conversion to NDMA is encouraged by the reaction with a nitrogen component (N₂, NH₃, NO₂, NO₃, or N₂O).

When the generation of NDMA is encouraged, the UV advanced oxidation processing device 130 needs to encourage decomposition of NDMA by increasing the UV lamp irradiation energy in the UV-AOP. That leads to an increase in the treatment cost.

On the other hand, the drainage water to be treated in the water treatment device 100 includes nitrogen compounds in high concentration. Moreover, the constituents and the nitrogen concentration of the nitrogen compounds in the drainage water keeps on changing.

In a conventional water treatment device, the analysis and the management of the nitrogen compounds is not performed in real time, and is not reflected in the treatment of the drainage water. Practically, a conventional water treatment device adds sodium hypochlorite in excess quantity into the drainage water (the membrane filtration feed water). Thus, in a conventional water treatment device, the trend is to aim for chloramine formation while maintaining flexibility with respect to the fluctuation in the water quality of the drainage water.

That is because, when the water quality of the drainage water changes to have excess nitrogen or significant chlorine consumption; if the chlorine dosage is not sufficient, then chlorine gets consumed by nitrogen thereby leading to the risk of no generation of chloramine that holds down the biological activity. In this way, if the chlorine dosage is small in regard to the water quality of the drainage water, it is difficult to achieve the desired organism disinfection effect, thereby likely blocking the filtration membrane in the subsequent stage (for example, the UF membrane) and making it difficult to continue with the operation of the UF membrane filtration device 110.

For that reason, regardless of the fluctuation in the water quality of the drainage water, a conventional water treatment device adds sodium hypochlorite in excess quantity in order to ensure that chloramine is formed in a more reliable manner.

In this way, a conventional water treatment device becomes a chloramine-dependent system with excess chlorine, and is likely to cause an increase in the treatment cost from the following three perspectives.
1) increase in the cost of the chemicals required in chloramine generation
2) increase in the power consumption attributed to the UV-AOP meant for causing oxidative decomposition of NDMA generated due to the reaction with dichloramine
3) deterioration in the RO membrane accompanying the decomposition of the aromatic polyamide material of the RO membrane (i.e., increase in the RO membrane replacement cost)

The water treatment system 10 according to the present embodiment appropriately controls the dosage of sodium hypochlorite according to the water quality of the drainage water (the membrane filtration feed water), and attempts a departure from a chloramine-dependent membrane filtration operation attributed to excess addition of chlorine (sodium hypochlorite).

### REFERENCE LITERATURE

[1] The Impact of monochloramines and dichloramines on reverse osmosis membranes in wastewater potable reuse process trains: Pilot-scale study (Environ. Sci. Water Res. Technol., 2020, 6, pp 1336-1346)
[2] Updated Rection Pathway for Dichloramine Decomposition: Formation of Reactive Nitrogen Species and N-Nitrosodimethylamine (Environ. Sci. Technol., 2021, 55, pp 1740-1749)

### <2.2. Exemplary Configuration of Control Device>

As explained above, the control device 200 according to the present embodiment changes the water treatment device 100 from a chloramine-dependent system to a low-chloramine-dependency system, and ensures that the monochloramine concentration generated in the drainage water (the membrane filtration feed water) is maintained within a predetermined concentration range.

More particularly, the control device 200 obtains information about the water quality of the membrane filtration feed water and, according to the water quality, decides on the dosage of sodium hypochlorite in such a way that the generated monochloramine has the concentration within a predetermined concentration range (for example, the zone 1 mentioned earlier). Moreover, the control device 200 decides on the dosage of ammonium sulphate or ammonium chloride in an identical manner.

For example, from the water quality of the membrane filtration feed water, the control device 200 predicts the nitrogen compounds present in the membrane filtration feed water and decides on the injection ratio of the chemicals (sodium hypochlorite and ammonium sulphate (or ammonium chloride)) meant for forming monochloramine of a predetermined concentration. Moreover, the prediction of the nitrogen compounds can be performed using simulation or using machine learning (an AI model).

As a result, the water treatment system 10 becomes able to hold down excessive addition of sodium hypochlorite and ammonium sulphate (or ammonium chloride), to appropriately control the dosage of such chemicals, and thus to reduce the dosage of the chemicals.

Moreover, the water treatment system 10 can maintain the monochloramine concentration within a predetermined concentration range, thereby being able to maintain the dichloramine concentration at a low level. As a result, the water treatment system 10 becomes able to hold down the generation of NDMA, and to hold down an increase in the power consumption during the UV-AOP. Moreover, the water treatment system 10 becomes able to hold down the deterioration of the RO membrane attributed to the decomposition of its aromatic polyamide material, and hence to hold down the replacement cost of the RO membrane.

Meanwhile, depending on the monochloramine concentration of the membrane filtration feed water, the residual microorganisms are likely to facilitate the occurrence of blockages in the UF membrane.

In that regard, the control device 200 according to the present embodiment predicts the blockage condition (permeability) of the UF membrane of the UF membrane filtration device 110. Then, for example, according to the prediction result, the control device 200 changes the cleaning frequency or the cleaning method (the concentration of the used chemicals) with respect to the UF membrane filtration device 110. For example, according to the prediction result, the control device 200 changes the quantity of the chemicals (sodium hypochlorite and ammonium sulphate (or ammonium chloride) to be added into the membrane filtration feed water.

Given below is the explanation of an exemplary configuration of the control device 200 that performs the operations explained above.

FIG. 5 is a block diagram illustrating an exemplary configuration of the control device 200 according to the present embodiment. The control device 200 illustrated in FIG. 5 includes a communication unit 210, a memory unit 220, and a control unit 230.

### (Communication Unit 210)

The communication unit 210 performs data communication with other devices. For example, the communication unit 210 performs communication with the devices included in the water treatment device 100.

### (Memory Unit 220)

The memory unit 220 is used to store a variety of information that is referred to by the control unit 230 during operations, and to store a variety of information obtained during the operations of the control unit 230. The memory unit 220 can be implemented, for example, using a semiconductor memory device such as a flash memory or using a memory device such as a hard disk or an optical disc. In the example illustrated in FIG. 5, the memory unit 220 is installed inside the control device 200. Alternatively, the memory unit 220 can be installed on the outside of the control device 200, or a plurality of memory units can be installed.

### (Control Unit 230)

The control unit 230 controls the entire control device 200 and the water treatment device 100. The control unit 230 includes an obtaining unit 231, a decision making unit 232, and a cleaning decision making unit 233. For example, the control unit 230 can be implemented using an electronic circuit such as a CPU (Central Processing Unit) or an MPU (Micro Processing Unit), or can be implemented using an integrated circuit such as an ASIC (Application Specific Integrated Circuit) or an FPGA (Field Programmable Gate Array).

### (Obtaining Unit 231)

The obtaining unit 231 obtains a variety of information from the water treatment device 100. For example, the obtaining unit 231 obtains pressure information related to a variety of pressures measured by the manometer 122 (see FIG. 3). Moreover, for example, the obtaining unit 231 obtains first-type UF membrane pressure information related to the pressure of the UF membrane feed water and obtains second-type UF membrane pressure information related to the pressure of the UF membrane permeable water. Furthermore, for example, the obtaining unit 231 obtains first-type RO membrane pressure information related to the pressure of the RO membrane feed water and obtains second-type RO membrane pressure information related to the pressure of the RO membrane permeable water.

Then, the obtaining unit 231 outputs the obtained pressure information to the decision making unit 232 and the cleaning decision making unit 233.

Moreover, the obtaining unit 231 obtains water quality information related to the water quality from, for example, the water quality sensors 140_1 to 140_3. For example, from the water quality sensor 1401, the obtaining unit 231 obtains UF-membrane water quality information related to the water quality of the UF membrane feed water. Moreover, for example, from the water quality sensor 1402, the obtaining unit 231 RO-membrane water quality information related to the water quality of the RO membrane feed water. Furthermore, for example, from the water quality sensor 140_3, the obtaining unit 231 obtains concentrated-water quality information related to the water quality of the RO membrane concentrated water.

Then, the obtaining unit 231 outputs the obtained UF-membrane water quality information, the obtained RO-membrane water quality information, and the obtained concentrated-water quality information to the decision making unit 232. Moreover, the obtaining unit 231 outputs the RO-membrane water quality information and the concentrated-water quality information to the cleaning decision making unit 233.

### (Decision Making Unit 232)

As illustrated in FIG. 5, the decision making unit 232 includes a first decision making unit 232a and a second decision making unit 232b.

### (First Decision Making Unit 232a)

The first decision making unit 232a decides on the dosage of the chemicals (sodium hypochlorite and ammonium sulphate (or ammonium chloride)) based on the UF-membrane water quality information. Moreover, the first decision making unit 232a decides on the dosage of the chemicals based on at least either the RO-membrane water quality information or the concentrated-water quality information.

For example, according to the water quality of the UF membrane feed water, the first decision making unit 232a decides on the dosage of the chemicals that are responsible for the formation of monochloramine of a predetermined concentration after the addition of sodium hypochlorite.

The first decision making unit 232a predicts, for example, the formation of monochloramine from the water quality of UF membrane feed water using simulation or using an AI model (hereinafter, referred to as a first AI model. The first AI model is assumed to be generated in advance using machine learning. Alternatively, while the water treatment is being performed by the water treatment device 100, the first AI model can be generated (updated) using machine learning.

For example, the first decision making unit 232a inputs, to the first AI model, at least one of the following items included in the UF-membrane water quality information: the water temperature, the pH value, the ORP value, the quantity of ammoniacal nitrogen, the quantity of nitrogen compounds, the turbidity, the ultraviolet absorbance, the electric conductivity, and the TOC value. The first decision making unit 232a decides on the dosage of the chemicals according to the output of the first AI model.

Moreover, the first decision making unit 232a can also input, to the first AI model, the water temperature, the pH value, and the ORP value specified in the RO-membrane water quality information and the concentrated-water quality information.

In this way, the first decision making unit 232a decides on the dosage of the chemicals according to the water quality and, in order to ensure that the concentration of monochloramine in the UF membrane feed water is within a predetermined range, decides on the dosage of the chemicals according to the monochloramine concentration.

Alternatively, the first decision making unit 232a can measure or predict the monochloramine concentration in the UF membrane feed water, and then decide on the dosage of the chemicals. In this way, the first decision making unit 232a can decide on the dosage of the chemicals according to the chloramine concentration in the UF membrane feed water.

Then, the first decision making unit 232a notifies the dosing device 150 (see FIG. 3) about the decided dosage of the chemicals.

### (Second Decision Making Unit 232b)

The second decision making unit 232b decides on the quantity of sodium hypochlorite and ammonium sulphate (or ammonium chloride), which is to be added into the UF membrane feed water, based on at least either the RO-membrane water quality information or the concentrated-water quality information. Moreover, according to the number of microorganisms present in at least either the RO membrane feed water or the RO membrane concentrated water, the second decision making unit 232b decides on the quantity of the chemicals (sodium hypochlorite and ammonium sulphate (ammonium chloride)) to be added, so as to ensure that the number of microorganisms decreases.

Alternatively, based on the pressure information, the second decision making unit 232b can decide on the quantity of the chemicals (sodium hypochlorite and ammonium sulphate (ammonium chloride)) to be added into the UF membrane feed water. The UF membrane and the RO membrane become blocked due to, for example, the microorganisms present in the treatment water. For that reason, if there is an increase in the microorganisms in the treatment water, the UF membrane and the RO membrane become blocked and the pressure of the treatment water increases. In that regard, based on the pressure information, the second decision making unit 232b decides on the quantity of the chemicals according to the blockage condition (permeability) of the UF membrane and the RO membrane, so that the UF membrane and the RO membrane do not easily get blocked.

The second decision making unit 232b uses, for example, an AI model (hereinafter, referred to as a third AI model) and decides on the dosage of the chemicals to be added into the UF membrane feed water. The third AI model is assumed to be generated in advance using machine learning. Alternatively, while the water treatment is being performed by the water treatment device 100, the third AI model can be generated (updated) using machine learning.

The second decision making unit 232b inputs, to the third AI model, at least either the TOF or the microorganism data specified in the RO-membrane water quality information and the concentrated-water quality information. According to the output of the third AI model, the second decision making unit 232b decides on the quantity of the chemicals to be added into the UF membrane feed water.

For example, using the third AI model, the second decision making unit 232b decides on the quantity of the chemicals to be added into the UF membrane feed water, so as to ensure a decrease in the number of microorganisms present in at least either the RO membrane feed water or the RO membrane concentrated water.

Moreover, the second decision making unit 232b can input, to the third AI model, the information obtained from the pressure information. For example, the second decision making unit 232b can input, to the third AI model, the following types of pressures obtained from the pressure information; and, according to the output of the third AI model, decides on the quantity of the chemicals to be added into the UF membrane feed water.
pressure of the UF membrane feed water (UF membrane driving pressure)
differential pressure between the UF membrane feed water and the UF membrane permeable water (inter-UF-membrane differential pressure)
pressure of the RO membrane feed water (RO membrane driving pressure)
differential pressure between the RO membrane concentrated water and the RO membrane feed water (inter-RO-membrane-module differential pressure)
differential pressure between the RO membrane permeable water and the RO membrane feed water (inter-RO-membrane differential pressure)

In that case, it is assumed that the third AI model learns such a dosage of the chemicals which enables achieving reduction in the inter-UF-membrane differential pressure, the inter-RO-membrane-module differential pressure, and the inter-RO-membrane differential pressure. That is, using the third AI model, the second decision making unit 232b decides on the dosage of the chemicals into the UF membrane feed water in such a way that there is a reduction in the inter-UF-membrane differential pressure, the inter-RO-membrane-module differential pressure, and the inter-RO-membrane differential pressure.

The second decision making unit 232b instructs the dosing device 150 to add the chemicals according to the decided dosage. For example, the second decision making unit 232b can instruct the dosing device 150 to add the chemicals according to the dosage decided as explained above (in the following explanation, referred to as a second-type dosage) instead of following the dosage decided by the first decision making unit 232a (hereinafter, referred to as a first-type dosage). In that case, the first-type dosage is overwritten by the second-type dosage, and the dosing device 150 is notified about the second-type dosage.

Alternatively, regarding the dosage to be instructed to the dosing device 150 (hereinafter, referred to as the instructed dosage), the second decision making unit 232b can make the decision based on the first-type dosage and the second-type dosage. For example, the second decision making unit 232b can calculate the instructed dosage by weighting the first-type dosage and the second-type dosage and then adding the weighted dosages.

The first decision making unit 232a optimizes the water treatment cost (for example, the dosage of the chemicals) according to the fluctuation in the water quality of the UF membrane feed water. The water quality of the UF membrane feed water fluctuates within a relatively shorter period of time (from a few hours to a few days) depending on the time of day (for example, nighttime or daytime) or the weather (for example, rainy weather or clear weather). The first decision making unit 232a optimizes the water treatment cost by following the fluctuating water quality of the UF membrane feed water that fluctuates within a relatively shorter period of time.

On the other hand, the second decision making unit 232b optimizes the water treatment cost (for example, the cost attributed to cleaning or membrane replacement and the dosage of the chemicals) according to the blockage condition of the UF membrane and the RO membrane. The blockage condition of the membrane fluctuates over a relatively longer period of time (from a few months to half year) according to the propagation of the microorganisms. Thus, the second decision making unit 232b optimizes the water treatment cost by following the fluctuating blockage condition of the membranes that fluctuates over a relatively longer period of time.

As explained above, in the case of weighting the first-type dosage and the second-type dosage and then adding the weighted dosages, the second decision making unit 232b can vary the weighting according to, for example, the short-term impact and the long-term impact on the water treatment cost.

Meanwhile, the second decision making unit 232b decides on the second-type dosage based on at least either the water quality information or the pressure information. However, the decision about the second-type dosage is not limited to that case.

For example, the second decision making unit 232b can decide on the second-type dosage based on the blockage condition (permeability) of at least either the UF membrane or the RO membrane. For example, according to the cost of membrane cleaning and the cost of chemical dosage, the second decision making unit 232b decides on the second-type dosage in such a way that the water treatment cost is further optimized.

In that regard, the second decision making unit 232b can decide on the second-type dosage according to the cleaning method (the cleaning timing and the chemical concentration used in cleaning) of at least either the UF membrane or the RO membrane. As explained later, the cleaning decision making unit 233 decides on the cleaning method according to the blockage condition of the UF membrane and the RO membrane. Thus, by deciding the second-type dosage according to the cleaning method, the second decision making unit 232b becomes able to decide on the second-type dosage according to the blockage condition of at least either the UF membrane or the RO membrane. In that case, the second decision making unit 232b inputs, for example, cleaning information related to the cleaning method to the third AI model.

Herein, it is explained that the first decision making unit 232a decides on the first-type dosage using the first AI model, and the second decision making unit 232b decides on the second-type dosage using the third AI model. That is, it is explained that the control unit 230 decides on the instructed dosage using the first AI model and the third AI model. However, the decision about the instructed dosage as taken by the control unit 230 is not limited to that case.

For example, the decision making unit 232 can decide on the instructed dosage using a single AI model (hereinafter, referred to as a fourth AI model) instead of using the first AI model and the third AI model. In that case, the decision making unit 232 inputs, to the fourth AI model, the information that would have been input to the first AI model and the third AI model, and decides on the instructed dosage based on the output obtained from the fourth AI model. In this way, the decision making unit 232 can optimize the water treatment cost using a single large AI model (the fourth AI model).

### (Cleaning Decision Making Unit 233)

The cleaning decision making unit 233 decides on the cleaning method for at least either the UF membrane of the UF membrane filtration device 110 or the RO membrane of the RO membrane filtration device 120 based on the at least either the RO-membrane water quality information or the concentrated-water quality information. Alternatively, the cleaning decision making unit 233 can decide on the cleaning method for at least either the UF membrane or the RO membrane based on the pressure information.

As the cleaning method for the UF membrane and the RO membrane, the cleaning decision making unit 233 decides on at least either the implementation frequency (implementation timings) of the MC and the RC or the concentration of the chemicals used in cleaning.

The cleaning decision making unit 233 decides on the cleaning method for the UF membrane and the RO membrane using an AI model (hereinafter, referred to as a second AI model). The second AI model is assumed to be generated in advance using machine learning. Alternatively, while the water treatment is being performed by the water treatment device 100, the second AI model can be generated (updated) using machine learning.

For example, the cleaning decision making unit 233 inputs, to the second AI model, at least either the TOF or the microorganism data included in the RO-membrane water quality information and the concentrated-water quality information. The cleaning decision making unit 233 decides on the cleaning method for the UF membrane and the RO method according to the output of the second AI model.

Alternatively, the cleaning decision making unit 233 can input, to the second AI model, the information obtained from the pressure information. For example, the second decision making unit 232b can input, to the second AI model, the following types of pressures obtained from the pressure information; and, according to the output of the second AI model, decides on the cleaning method for the UF membrane and the RO membrane.
pressure of the UF membrane feed water (UF membrane driving pressure)
differential pressure between the UF membrane feed water and the UF membrane permeable water (inter-UF-membrane differential pressure)
pressure of the RO membrane feed water (RO membrane driving pressure)
differential pressure between the RO membrane concentrated water and the RO membrane feed water (inter-RO-membrane-module differential pressure)
differential pressure between the RO membrane permeable water and the RO membrane feed water (inter-RO-membrane differential pressure)

In that case, it is assumed that the second AI model learns such a cleaning method which enables achieving reduction in the inter-UF-membrane differential pressure, the inter-RO-membrane-module differential pressure, and the inter-RO-membrane differential pressure. That is, using the second AI model, the cleaning decision making unit 233 decides on the cleaning method in such a way that there is a reduction in the inter-UF-membrane differential pressure, the inter-RO-membrane-module differential pressure, and the inter-RO-membrane differential pressure.

Herein, the cleaning decision making unit 233 decides on the cleaning method using the second AI model. Alternatively, the cleaning decision making unit 233 can decide on the cleaning method without using the second AI model. For example, the cleaning decision making unit 233 can decide on the cleaning method according to the chloramine concentration in the UF membrane filtration device 110 and the RO membrane filtration device 120 of the water treatment device 100.

For example, the cleaning decision making unit 233 measures (or predicts) the chloramine concentration in the UF membrane feed water and, if the chloramine concentration is equal to or greater than a first threshold value (for example, 2 mg/L), shortens the cleaning interval (for example, seven days) for the UF membrane. On the other hand, if the chloramine concentration is smaller than a second threshold value (for example, 0.5 mg/L), then the cleaning decision making unit 233 lengthens the cleaning timing (for example, one month) for the UF membrane. In an identical manner, regarding the cleaning of the RO membrane too, the cleaning decision making unit 233 makes a decision according to the chloramine concentration in the RO membrane feed water. Meanwhile, the control unit 230 can predict the chloramine concentration using simulation or an AI model.

As a result, the cleaning decision making unit 233 can optimize the cleaning sequence of the water treatment device 100.

### <3. Control Operation>

### <3.1. First Decision Making Operation>

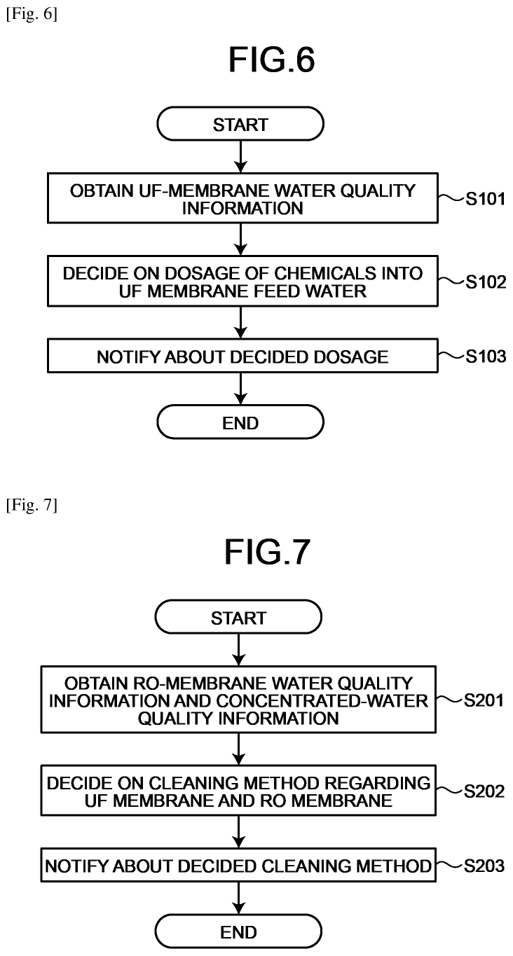

FIG. 6 is a flowchart for explaining an exemplary flow of a first decision making operation according to the present embodiment. For example, while the water treatment device 100 is performing water treatment, the first decision making operation is repeatedly performed by the first decision making unit 232a of the control unit 230.

As illustrated in FIG. 6, the first decision making unit 232a obtains the UF membrane water quality information related to the water quality of the UF membrane feed water from the water quality sensor 140_1 via the obtaining unit 231 (Step S101).

Based on the UF-membrane water quality information, the first decision making unit 232a uses, for example, the first AI model and decides on the dosage of chemicals into the UF membrane feed water (i.e., decides on the first-type dosage) (Step S102).

The first decision making unit 232a notifies the dosing device 150 about the decided dosage (the first-type dosage) (Step S103). Meanwhile, when the second decision making unit 232b decides on the instructed dosage, the first decision making unit 232a can notify the second decision making unit 232b about the first-type dosage.

Herein, the first decision making unit 232a decides on the first-type dosage based on the UF-membrane water quality information. However, alternatively, the first decision making unit 232a can decide on the first-type dosage based on the RO-membrane water quality information, which is related to the water quality of the RO membrane feed water, and based on the concentrated-water quality information, which is related to the water quality of the RO membrane concentrated water.

In that case, at Step S101, the first decision making unit 232a obtains the RO-membrane water quality information and the concentrated-water quality information from the water quality sensors 140_2 and 140_3 via the obtaining unit 231. At Step S102, based on the RO-membrane water quality information and the concentrated-water quality information, the first decision making unit 232a decides on the first-type dosage using, for example, the first AI model.

### <3.2. Cleaning Decision Making Operation>

FIG. 7 is a flowchart for explaining an exemplary flow of a cleaning decision making operation according to the present embodiment. For example, while the water treatment device 100 is performing water treatment, the cleaning decision making operation is repeatedly performed by the cleaning decision making unit 233 of the control unit 230.

As illustrated in FIG. 7, the cleaning decision making unit 233 obtains the RO-membrane water quality information, which is related to the water quality of the RO membrane feed water, and the concentrated-water quality information, which is related to the water quality of the RO membrane concentrated water, from the water quality sensors 140_2 and 140_3 via the obtaining unit 231 (Step S201).

Based on the RO-membrane water quality information and the concentrated-water quality information, the cleaning decision making unit 233 decides on the cleaning method (for example, the cleaning timing and the chemical concentration to be used in cleaning) using, for example, the second AI model (Step S202).

Then, the cleaning decision making unit 233 notifies the cleaning unit 113 of the UF membrane filtration device 110 and the cleaning unit 123 of the RO membrane filtration device 120 about the decided cleaning method (Step S203). Thus, according to the cleaning method decided by the cleaning decision making unit 233, the cleaning units 113 and 123 clean the UF membrane and the RO membrane, respectively.

Herein, the cleaning decision making unit 233 decides on the cleaning method based on the RO-membrane water quality information and the concentrated-water quality information. However, alternatively, the cleaning decision making unit 233 can decide on the cleaning method based on the pressure information.

In that case, at Step S201, via the obtaining unit 231, the cleaning decision making unit 233 obtains the pressure information from the manometer 112 of the UF membrane filtration device 110 and from the manometer 122 of the RO membrane filtration device 120. At Step S202, based on the obtained pressure information, the cleaning decision making unit 233 decides on the cleaning method using, for example, the second AI model.

### <3.3. Second Decision Making Operation>

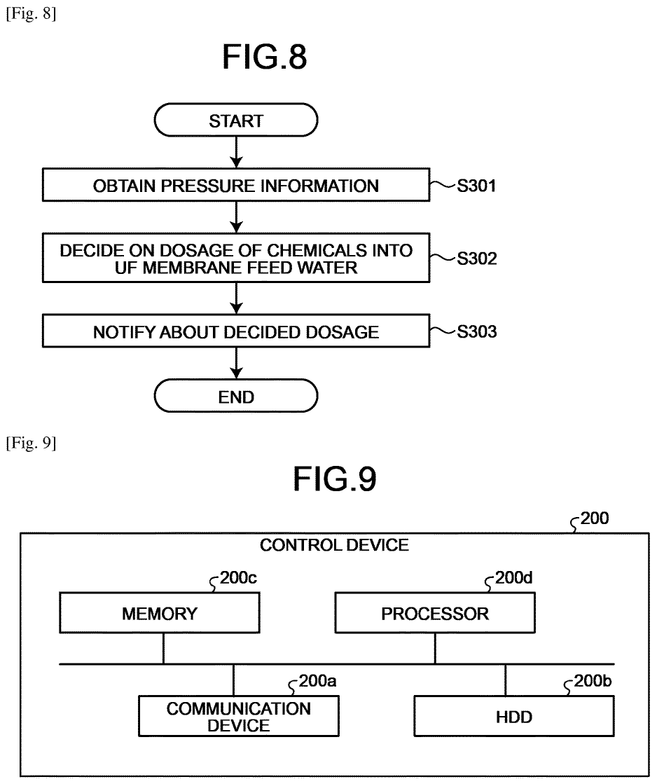

FIG. 8 is a flowchart for explaining an exemplary flow of a second decision making operation according to the present embodiment. For example, while the water treatment device 100 is performing water treatment, the second decision making operation is repeatedly performed by the second decision making unit 232b of the control unit 230.

As illustrated in FIG. 8, via the obtaining unit 231, the second decision making unit 232b obtains the pressure information from the manometer 112 of the UF membrane filtration device 110 and from the manometer 122 of the RO membrane filtration device 120 (Step S301).

Based on the pressure information, the second decision making unit 232b decides on the dosage of the chemicals into the UF membrane feed water (the second-type dosage) using, for example, the third AI model (Step S302).

Then, the second decision making unit 232b notifies the dosing device 150 about the decided dosage (the second-type dosage) (Step S303). Meanwhile, in the case of deciding on the instructed dosage, the second decision making unit 232b can decide on the instructed dosage based on the first-type dosage, which is obtained from the first decision making unit 232a, and the already-decided second-type dosage. In that case, the second decision making unit 232b notifies the dosing device 150 about the instructed dosage.

Herein, the second decision making unit 232b decides on the second-type dosage based on the pressure information. However, alternatively, the second decision making unit 232b can decide on the second-type dosage based on the RO-membrane water quality information related to the water quality of the RO membrane feed water and the concentrated-water quality information related to the water quality of the RO membrane concentrated water.

In that case, at Step S301, via the obtaining unit 231, the second decision making unit 232b obtains the RO-membrane water quality information and the concentrated-water quality information from the water quality sensors 140_2 and 140_3. Then, at Step S302, based on the RO-membrane water quality information and the concentrated-water quality information, the second decision making unit 232b decides on the second-type dosage using, for example, the third AI model.

### <4. System>

The processing procedures, the control procedures, specific names, various data, and information including parameters described in the embodiment or illustrated in the drawings can be changed as required unless otherwise specified.

The constituent elements of the device illustrated in the drawings are merely conceptual, and need not be physically configured as illustrated. The constituent elements, as a whole or in part, can be separated or integrated either functionally or physically based on various types of loads or use conditions.

The process functions implemented in the device are entirely or partially implemented by a CPU or by computer programs that are analyzed and executed by a CPU, or are implemented as hardware by wired logic.

### <5. Hardware>

Given below is the explanation of an exemplary hardware configuration of the control device 200 that is an information processing device. FIG. 9 is a diagram for explaining an exemplary hardware configuration of the control device 200. As illustrated in FIG. 9, the control device 200 includes a communication device 200a, an HDD (Hard Disk Drive 200b), a memory 200c, and a processor 200d. Moreover, the constituent elements illustrated in FIG. 9 are connected to each other by a bus.

The communication device 200a is a network interface card that performs communication with other servers. The HDD 200b is used to store programs and databases meant for implementing the functions illustrated in FIG. 5.

The processor 200d reads a program, which is written for executing the operations identical to the processing units illustrated in FIG. 5, from the HDD 200b and loads it in the memory 200c. As a result, a process is run that is meant for implementing the functions explained with reference to FIG. 5. For example, the process implements functions identical to the processing units included in the control device 200. More particularly, the processor 200d reads, from the HDD 200b, a program that is equipped with identical functions to the obtaining unit 231, the decision making unit 232, and the cleaning decision making unit 233. Then, the processor 200d executes a process that implements the operations identical to the obtaining unit 231, the decision making unit 232, and the cleaning decision making unit 233.

In this way, the control device 200 operates as a device that reads and executes a program and implements various processing methods. Alternatively, the control device 200 can read the abovementioned program from a recording medium using a medium reading device, execute the read program, and implement the functions identical to the embodiment described above. Meanwhile, the program according to the present embodiment is not limited to be executed by the control device 200. For example, even when some other computer or a server executes the program or when such devices execute the program in cooperation, the present invention can still be applied in an identical manner.

Still alternatively, the abovementioned program can be distributed via a network such as the Internet. Still alternatively, the abovementioned program can be recorded in a computer-readable recording medium such as a hard disk, a flexible disk (FD), a CDROM, an MO (Magneto-Optical disk), or a DVD (Digital Versatile Disc). Thus, a computer can read the program from the recording medium and execute it.

### <6. Miscellaneous>

Given below is the explanation of some combinations of the technical features disclosed herein.

(1)

A control device comprising:
an obtaining unit that, in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, obtains water quality information related to water quality of feed water which is supplied to the MF membrane or the UF membrane of the membrane filtration device; and
a decision making unit that, according to the water quality information, decides on quantity of sodium hypochlorite to be added into the MF membrane or the UF membrane of the membrane filtration device.
   (2)

The control device according to (1), wherein the decision making unit decides on the quantity of the sodium hypochlorite according to concentration of chloramine which is formed as a result of adding the sodium hypochlorite.

(3)

The control device according to (2), wherein the deciding unit decides on the quantity of the sodium hypochlorite using an AI model which treats the water quality information as input.

(4)

The control device according to any one of (1) to (3), wherein the water quality information includes at least one of water temperature, pH value, ORP (Oxidation-Reduction Potential) value, ammoniacal nitrogen content, nitrogen compound content, turbidity, ultraviolet absorbance, electrical conductivity, and TOC (Total Organic Carbon) value of the feed water.

(5)

The control device according to any one of (1) to (4), wherein the decision making unit decides on the quality of the sodium hypochlorite according to at least either cleaning timing of the MF membrane or the UF membrane or cleaning timing of the NF membrane or the RO membrane to which membrane filtration permeable water obtained due to passage through the MF membrane or the UF membrane is supplied.

(6)

The control device according to (5), wherein the deciding unit decides on the quantity of the sodium hypochlorite using an AI model which treats information related to the cleaning timing as input.

(7)

The control device according to any one of (1) to (6), wherein
the obtaining unit obtains second-type water quality information related to water quality of at least either membrane filtration permeable water, which is obtained due to passage through the MF membrane or the UF membrane, or reverse osmosis concentrated water, which is separated using the NF membrane or the RO membrane to which the membrane filtration permeable water is supplied, and
the deciding unit decides on the quantity of the sodium hypochlorite according to the second-type water quality information.
   (8)

The control device according to (7), wherein the second-type water quality information contains at least either one of water temperature, pH value, ORP value TOC value, and microorganism content of at least either the membrane filtration permeable water or the reverse osmosis membrane concentrated water.

(9)

The control device according to (7) or (8), wherein the deciding unit decides on the quantity of the sodium hypochlorite in such a way that there is reduction in number of microorganisms included in at least either the membrane filtration permeable water or the reverse osmosis membrane concentrated water.

(10)

The control device according to any one of (1) to (9), wherein the deciding unit decides on the quantity of the sodium hypochlorite according to at least either permeability of the MF membrane or the UF membrane or permeability of the NF membrane or the RO membrane to which membrane filtration permeable water obtained due to passage through the MF membrane or the UF membrane is supplied.

(11)

The control device according to (10), wherein the obtaining unit includes, as the permeability, at least one of
first-type pressure information related to pressure of the feed water supplied to the MF membrane or the UF membrane,
second-type pressure information related to inter-membrane differential pressure of the MF membrane or the UF membrane,
third-type pressure information related to pressure of the membrane filtration permeable water supplied to the NF membrane or the RO membrane,
fourth-type pressure information related to difference between pressure of the membrane filtration permeable water and pressure of reverse osmosis membrane concentrated water obtained by separation using the NF membrane or the RO membrane, and
fifth-type pressure information related to inter-membrane differential pressure of the NF membrane or the RO membrane.
   (12)

The control device according to (11), wherein the deciding unit decides on the quantity of the sodium hypochlorite to ensure that there is reduction in at least one value from among the second-type pressure information, the fourth-type pressure information, and the fifth-type pressure information.

(13)

A control method implemented in a computer, comprising:
obtaining that, in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, includes obtaining water quality information related to water quality of feed water which is supplied to the MF membrane or the UF membrane of the membrane filtration device; and
deciding that, according to the water quality information, includes deciding on quantity of sodium hypochlorite to be added into the MF membrane or the UF membrane of the membrane filtration device.
   (14)

A control program that causes a computer to execute:
obtaining that, in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, includes obtaining water quality information related to water quality of feed water which is supplied to the MF membrane or the UF membrane of the membrane filtration device; and
deciding that, according to the water quality information, includes deciding on quantity of sodium hypochlorite to be added into the MF membrane or the UF membrane of the membrane filtration device.

### REFERENCE SIGNS LIST

10 water treatment system
100 water treatment device
110 UF membrane filtration device
111, 121 pump
112, 122 manometer
113, 123 cleaning unit
120 RO membrane filtration device
130 UV advanced oxidation processing device
140 water quality sensor
150 dosing device
200 control device
210 communication unit
220 memory unit
230 control unit
231 obtaining unit
232 deciding unit
233 cleaning decision making unit

1. A control device comprising:
a processor configured to:
in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, obtain water quality information related to water quality of feed water which is supplied to the MF membrane or the UF membrane of the membrane filtration device; and
according to the water quality information, decide on quantity of sodium hypochlorite to be added into the MF membrane or the UF membrane of the membrane filtration device.

2. The control device according to claim 1, wherein the processor is further configured to decide on the quantity of the sodium hypochlorite according to concentration of chloramine which is formed as a result of adding the sodium hypochlorite.

3. The control device according to claim 2, wherein the processor is further configured to decide on the quantity of the sodium hypochlorite using an AI model which treats the water quality information as input.

4. The control device according to claim 1, wherein the water quality information includes at least one of water temperature, pH value, ORP (Oxidation-Reduction Potential) value, ammoniacal nitrogen content, nitrogen compound content, turbidity, ultraviolet absorbance, electrical conductivity, and TOC (Total Organic Carbon) value of the feed water.

5. The control device according to claim 1, wherein the processor is further configured to the decide on the quality of the sodium hypochlorite according to at least either cleaning timing of the MF membrane or the UF membrane or cleaning timing of the NF membrane or the RO membrane to which membrane filtration permeable water obtained due to passage through the MF membrane or the UF membrane is supplied.

6. The control device according to claim 5, wherein the processor is further configured to decide on the quantity of the sodium hypochlorite using an AI model which treats information related to the cleaning timing as input.

7. The control device according to claim 1, wherein
the processor is further configured to:
obtain second-type water quality information related to water quality of at least either membrane filtration permeable water, which is obtained due to passage through the MF membrane or the UF membrane, or reverse osmosis concentrated water, which is separated using the NF membrane or the RO membrane to which the membrane filtration permeable water is supplied, and
decide on the quantity of the sodium hypochlorite according to the second-type water quality information.

8. The control device according to claim 7, wherein the second-type water quality information contains at least either one of water temperature, pH value, ORP value TOC value, and microorganism content of at least either the membrane filtration permeable water or the reverse osmosis membrane concentrated water.

9. The control device according to claim 7, wherein the processor is further configured to decide on the quantity of the sodium hypochlorite in such a way that there is reduction in number of microorganisms included in at least either the membrane filtration permeable water or the reverse osmosis membrane concentrated water.

10. The control device according to claim 1, wherein the processor is further configured to decide on the quantity of the sodium hypochlorite according to at least either permeability of the MF membrane or the UF membrane or permeability of the NF membrane or the RO membrane to which membrane filtration permeable water obtained due to passage through the MF membrane or the UF membrane is supplied.

11. The control device according to claim 10, wherein the processor is further configured to include, as the permeability, at least one of
first-type pressure information related to pressure of the feed water supplied to the MF membrane or the UF membrane,
second-type pressure information related to inter-membrane differential pressure of the MF membrane or the UF membrane,
third-type pressure information related to pressure of the membrane filtration permeable water supplied to the NF membrane or the RO membrane,
fourth-type pressure information related to difference between pressure of the membrane filtration permeable water and pressure of reverse osmosis membrane concentrated water obtained by separation using the NF membrane or the RO membrane, and
fifth-type pressure information related to inter-membrane differential pressure of the NF membrane or the RO membrane.

12. The control device according to claim 11, wherein the processor is further configured to decide on the quantity of the sodium hypochlorite to ensure that there is reduction in at least one value from among the second-type pressure information, the fourth-type pressure information, and the fifth-type pressure information.

13. A control method comprising:
obtaining that, in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, includes obtaining water quality information related to water quality of feed water which is supplied to the MF membrane or the UF membrane of the membrane filtration device; and
deciding that, according to the water quality information, includes deciding on quantity of sodium hypochlorite to be added into the MF membrane or the UF membrane of the membrane filtration device, using a processor.

14. A non-transitory computer-readable recording medium having stored therein a control program that causes a computer to execute:
obtaining that, in an inflow portion of a membrane filtration device in which an MF membrane (MicroFiltration membrane), an UF membrane (UltraFiltration membrane), an NF membrane (NanoFiltration Membrane), or an RO membrane (ReverseOsmosis) membrane is used, includes obtaining water quality information related to water quality of feed water which is supplied to the MF membrane or the UF membrane of the membrane filtration device; and
deciding that, according to the water quality information, includes deciding on quantity of sodium hypochlorite to be added into the MF membrane or the UF membrane of the membrane filtration device.
